(19) United States
(12) Patent Application Publication
(10) Pub. No.: US 2025/0392050 A1
(43) Pub. Date: Dec. 25, 2025

(54) MULTI-OCTAVE ANTENNA ELEMENT

(71) Applicant: The Aerospace Corporation, El Segundo, CA (US)

(72) Inventor: Mark J. LANGE, Malibu, CA (US)

(73) Assignee: The Aerospace Corporation, El Segundo, CA (US)

(21) Appl. No.: 18/752,223

(22) Filed: Jun. 24, 2024

(51) Int. Cl. H01Q 13/02; H01Q 1/48; H01Q 1/50

(52) U.S. Cl. CPC H01Q 13/0208; H01Q 1/48; H01Q 1/50

(57) ABSTRACT

A multi-octave antenna element with a multi-octave frequency range simultaneously with a wide FOV. The multi-octave antenna element may be used in an array with other antenna elements, and may operate across with a wide element beamwidth in the 3 GHz to 11 GHz Ultra-Wideband (UW) frequency spectra designated by the Federal Communications Commission (FCC) and the International Telecommunication Union (ITU) for unlicensed, low power, communication. The antenna is scalable to any other 3:1 frequency band desired.

### FIELD

The present invention generally pertains to antennas, and more particularly, to multi-octave antenna element, which may be used independently or in an array with other multi-octave antenna elements.

### BACKGROUND

Antenna elements, such as spiral or sinuous antennas, are known to provide wide bandwidths over multiple octaves. These antennas provide a constant and relatively narrow 3 dB beamwidth, which is approximately 70 degrees across multiple octaves. When these antennas are used in an array, their narrow beamwidths prevent the array from scanning over a wide field of view (FOV) without incurring significant scan loss.

Beam scan angles for many arrays are typically desired to be on the order of 120 degrees or more. While these antennas operate over wide frequency ranges, they cannot provide the wide FOV required of many important applications.

Furthermore, other wideband antenna elements, such as Vivaldi or numerous variations of the Vivaldi in planar or 3D form, typically have a very large height to width aspect ratio. These wideband antenna elements are specifically made to be tall in order to achieve a low frequency. Additionally, these wideband antenna elements are very narrow in width to enable a close element spacing when used in an array. This approach results in a voluminous antenna array with a high density of antenna elements. This high density and voluminous array results in high size, weight, power and cost.

Other wideband antennas, such as monopoles, are not suited for use in an array as they have a null in the gain pattern that is normal to the ground plane. Finally, biconical antennas also have wide bandwidth; however, their beamwidth decreases significantly with increasing frequency.

Accordingly, an improved a multi-octave antenna element may be beneficial.

### SUMMARY

Certain embodiments of the present invention may provide solutions to the problems and needs in the art that have not yet been fully identified, appreciated, or solved by current space-based communication technology. For example, some embodiments of the present invention pertain to a multi-octave antenna element with a multi-octave frequency range simultaneously with a wide FOV.

In an embodiment, an apparatus includes a connector with a distal end protruding out of the apparatus and a proximal end encroaching or extending across at least one pair of ridges, and a ridge waveguide configured to receive a signal from a balun and propagate the signal upward and out of the apparatus. The ridge waveguide includes the at least one pair of ridges protruding out of the ridge waveguide and terminating at or merging with a pair of spherical elements.

In another embodiment, an apparatus includes a waveguide input configured to receive a signal from an external source, and propagate the signal upward and out of the apparatus. The waveguide is located below a ground plane in such embodiments.

In yet another embodiment, an apparatus includes a connector with a distal end protruding out of the apparatus and a proximal end terminating at or on a front surface of an opposite ridge forming a short circuit, and a waveguide configured to receive a signal from a balun and propagate the signal upward and out of the apparatus. The waveguide includes a pair of ridges protruding out and terminating at or merging with a pair of spherical elements.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIGS. 1A-E illustrate a single multi-octave antenna element without an associated ground plane, according to an embodiment of the present invention.

FIG. 2 illustrates a single multi-octave antenna element with an associated ground plane, according to an embodiment of the present invention.

FIG. 3 is a flow diagram illustrating a process for receiving and transmitting with the single multi-octave antenna element, according to an embodiment of the present invention.

FIG. 4 is a graph illustrating an antenna return loss across 3 octaves of bandwidth, according to an embodiment of the present invention.

FIG. 5 is a diagram illustrating antenna radiation patterns over a small ground plane, according to an embodiment of the present invention.

FIGS. 6A-E are diagrams illustrating a single linear polarized antenna with a vertical oriented connector, according to an embodiment of the present invention.

FIGS. 7A-D are diagrams illustrating a dual linear polarized antenna with a plurality of connectors, according to an embodiment of the present invention.

FIG. 8 is a diagram illustrating the propagation of fields through each part of the antenna, according to an embodiment of the present invention.

FIGS. 9A and 9B are diagrams illustrating a single multi-octave antenna element with a waveguide input port ideal for use with high power transmission, according to an embodiment of the present invention.

### DETAILED DESCRIPTION OF THE EMBODIMENTS

Some embodiments pertain to one or more multi-octave antenna element with a multi-octave frequency range simultaneously with a wide FOV. For purposes of explanation, multi-octave antenna element will be referred to as “antenna element”. In some additional embodiments, the antenna element may be used in an array with other antenna elements. In one example, a multi-octave frequency range may operate across with a wide element beamwidth in the 3 GHz to 11 GHz Ultra-Wideband (UW) frequency spectra designated by the Federal Communications Commission (FCC) and the International Telecommunication Union (ITU) for unlicensed, low power, communication.

In certain embodiments, the antenna element is comprised of a coaxial fed dual ridged waveguide with a cavity backed balun on one end of the dual ridged waveguide, and a balanced transmission line on the other side of the dual ridged waveguide. This balanced transmission line is configured with substantially the same cross section as the ridges in the dual ridged waveguide. Further, when a ground plane is used the balanced transmission line protrudes through an aperture in the ground plane. The balanced transmission line is terminated in a multi-octave matched radiator, and the multi-octave matched radiator for each side of the transmission line is a second order 3-dimensional body of revolution or a second order 3-dimensional asymmetric solid object. It should be appreciated that the multi-octave matched radiator matches the impedance of the ridges to that of free space and provides the current distribution needed to obtain the constant wide beamwidth across the wide band.

It should be appreciated that the components of the antenna element operate across the same band. The antenna element may be scaled up or down in frequency to operate across multiple octaves in other frequency ranges.

The combination of a dual ridge waveguide feed that terminates at the ground plane provides good forward directivity at the interface of the ground plane. This allows for further guidance of the fields along the balanced transmission line and exciting of the multi-octave matched radiators at the top and sides (but not the bottom). This combination may produce a desired wide antenna beamwidth without a back lobe that would normally result in destructive interference at several frequencies across the multiple octave bandwidth.

In short, the antenna element is suited for use in a multi-octave electronically scanned array antenna.

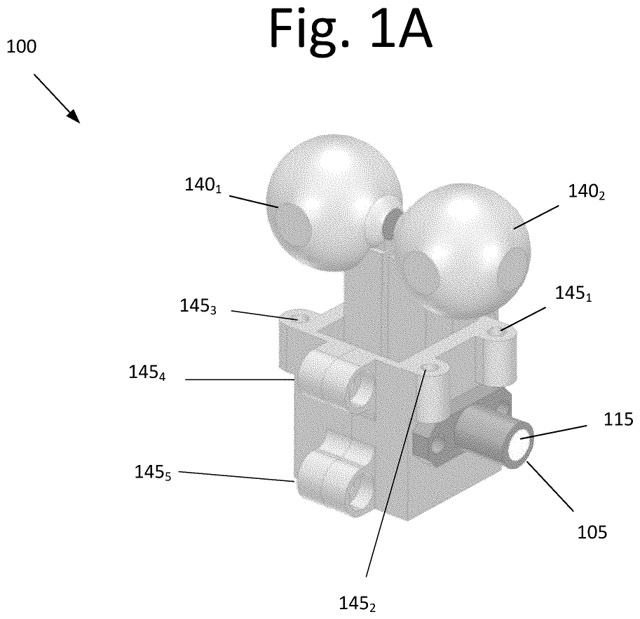

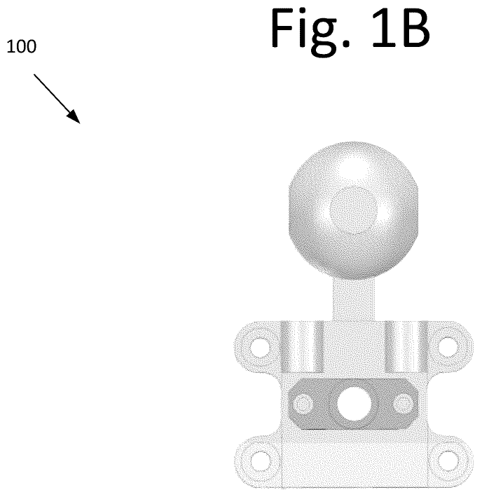

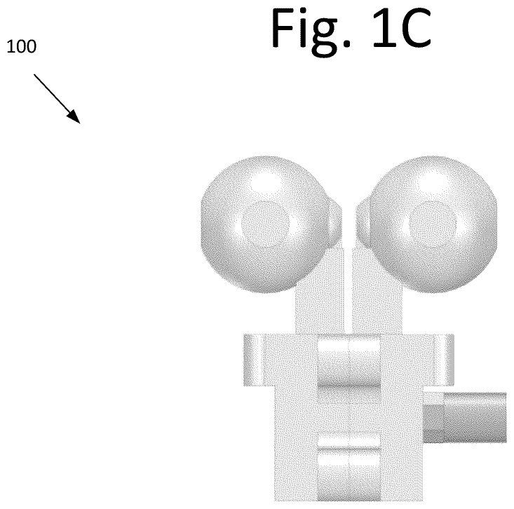

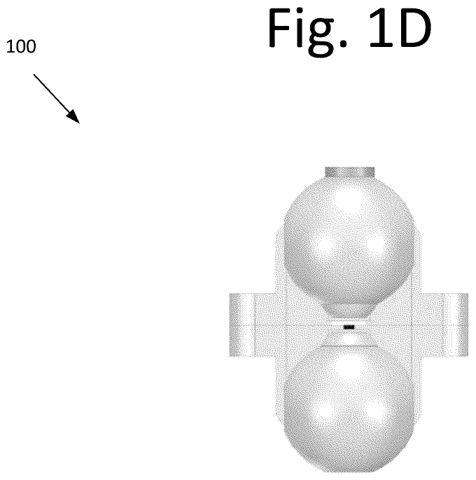

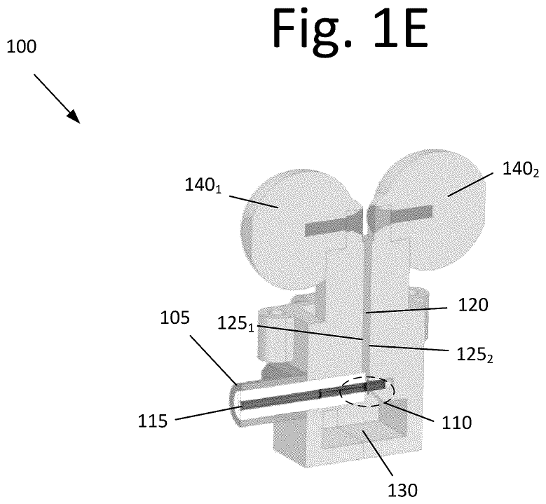

FIGS. 1A-E illustrate a single multi-octave antenna element (the “antenna element”) 100 without an associated ground plane, according to an embodiment of the present invention.

In some embodiments, antenna element 100 comprises a dual ridge or quad ridge waveguide that transitions into a small section. The small section includes only the ridges without the waveguide walls, and then terminates in a multi-octave matched radiator of multiple spheres or ellipsoids. In these embodiments, each ridge is terminated with a multi-octave matched radiator.

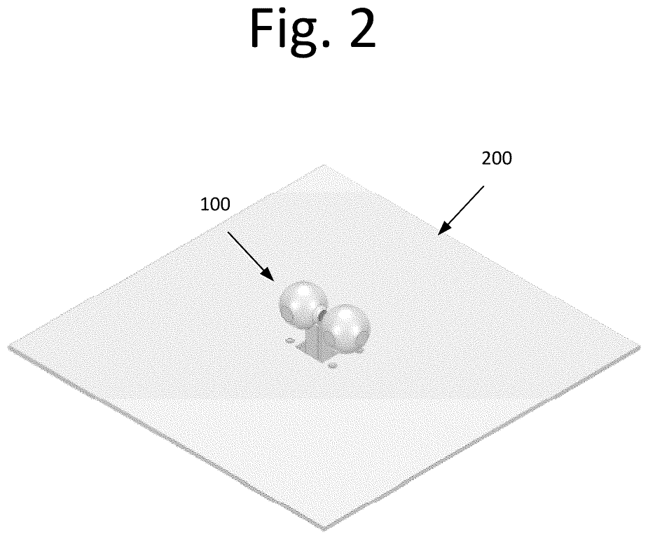

In an embodiment, antenna element 100 comprises a coaxial connector and cavity that form a balun such that the current on the opposing ridges carry equal and opposite currents. The fields propagating along the ridges of the waveguide provide enough directivity when exciting the spheres such that the potential negative effects of a ground plane multipath interference are eliminated while the positive effects of the ground plane front-to-back ratio are maintained. See, for example, FIG. 2, which illustrates a single multi-octave antenna element 100 with an associated ground plane 200, according to an embodiment of the present invention.

Returning to FIGS. 1A-E, antenna element 100, in some embodiments, may provide operation across three octaves of bandwidth or more. This antenna element 100 is a lower profile antenna with the desired bandwidth. Antenna element 100 may be used for proximity operations to measure range between a pair of satellites, for example.

Antenna element 100 also offers a wide FOV, i.e., a wide beamwidth, for transmitting and receiving signals. This is not typical of wideband antennas. To do this, a plurality of antenna elements may be arranged together to form an array of antenna elements. The antenna elements having wide beamwidths are formed together to form a narrow beam. This narrow beam can be scanned off of the broadside, about plus or minus sixty degrees, at any frequency across three octaves. See, for example, FIG. 2, illustrates a single multi-octave antenna element 100 with an associated ground plane 200, according to an embodiment of the present invention. Although FIG. 2 shows a single antenna element 100, there may be a plurality of antenna elements on ground plane 200. As shown in FIG. 2, the multi-octave matched radiators of multiple spheres are above ground plane while the remaining elements of antenna elements 100 are below ground plane 200. This configuration has a low profile antenna maintaining a wide bandwidth. The unique feature of these embodiments are the wideband elements with the broad beamwidth, and being compact in size.

Returning to FIG. 1, a feedline 105 protrudes out of antenna element 100. Feedline may include coaxial connector, microstrip, slot line, a microstrip. For purposes of explanation, coaxial connector 105 will be referred to as radio frequency (RF) coaxial connector 105. In some embodiments, coaxial connector 105 may operate from 6 GHZ to 18 GHz, which is approximately 300 percent bandwidth. In some embodiments, antenna element 100 is scalable up or down in frequency, and the type of coaxial connector 105 used may depend on the frequency of operation. For example, connectors that may be used include, but are not limited to, a N connector (operating at 3 GHZ), SMA connector (operating at 18 GHz), 3.5 mm connector (operating at 34 GHz), 2.92 mm connector (operating at 40 GHz), 2.4 mm connector (operating at 50 GHz), and 1.85 mm connector (operating at 67 GHZ). In one example, an SMA connector may operate anywhere from DC to 18 GHz with a maximum RF power of about 30 W depending on the manufacturers tolerances and materials used. The short length of transmission line of coaxial connector 105 that extends into the BALUN may be key for these embodiments. In one example, an SMA connector may be used due to its operating frequency range.

In another embodiment, a microstrip line may be used to perform the same function as the coaxial conductors for part of the balun. These embodiments may be more useful at the higher microwave frequencies or millimeter wave frequencies. In yet another embodiment, the ridges are fed directly with a printed slot line or a ridged waveguide. Because the slot line and the waveguide are already balanced, the balun may not be required. This embodiment may be used when the electronics need to be tightly integrated with the antenna to achieve reduced size and weight or improved performance at higher frequencies.

Coaxial connector 105 may form a balun 110. In this embodiment, balun 110 may be defined as a structure that converts an un-balanced transmission line (e.g., coaxial conductors or microstrip line) into a balanced transmission line (e.g., slot line or waveguide). It should be understood that it is the currents on the conductors that are either balanced or un-balanced. It should be noted that coaxial connector 105 is an unbalanced transmission line, and in some embodiments, the combination of coaxial (outer) connector 101 and (center) conductor 115 going into dual ridges 125₁ and 125₂ forms balun 110.

In some embodiments, coaxial connector 101 is comprised of two conductors—outer conductor 105 and center conductor 115. The ratio of the diameters of outer conductor 105 and center conductor 115, along with the Teflon dielectric (not numbered) that physically supports center conductor 115 inside outer conductor 105, provides a 50 Ohm characteristic impedance. Center conductor 115 crosses gap 120 between ridges 125₁ and 125₂ and enters a small hole within ridge 125₂. The small hole is sized to provide a very low characteristic Impedance (e.g., on the order of 2-10 Ohms). Center conductor 115 may be less than a quarter wavelength at the center frequency and may be terminated in open circuit (e.g., it does not touch ridge 125₂). This open circuited stub approach to forming the balun in two ridges 125₁ and 125₂ makes the manufacturing of the balun easier. In an alternative embodiment, and as discussed in detail later, a short circuit of center conductor 115 right at front edge of ridge 125₂ may be provided.

As discussed above, and in some embodiments, within coaxial connector 105 is a conductor (or rod or probe) 115. In certain embodiments, conductor 115 may be composed of a copper wire (or gold plate beryllium copper). Surrounding conductor 115 is a Teflon or other low loss dielectric material that stops at ridge 125₁. Conductor 115, however, jumps across/through gap 120 and goes into a hole in ridge 125₂. Gap 120, in this embodiment, is formed by dual ridges 125₁ and 125₂, and is part of the rectangular (or dual ridge) waveguide. Although a rectangular waveguide is described herein, the waveguide may be any shape, e.g., square waveguide or cylindrical. The dual ridges 125₁ and 125₂ turns the waveguide into a wide band waveguide.

Since most transmitters, receivers, transmission lines and connectors are designed to have a characteristic impedance of 50 Ohms, it is important to have every transition and transmission line matched to 50 Ohms across the entire band of interest. The coaxial connector, BALUN and ridged waveguide are all matched to 50 Ohms. The gap between the ridges sets the impedance of the waveguide to 50 Ohms at the higher frequencies while the ratio of width to height of the waveguide walls sets the low frequency impedance. Since the impedance of any transmission line is the square root of L/C (Inductance/Capacitance), changing the gap between the two ridges changes the capacitance and the impedance especially at the higher frequencies. Since the wavelength is smaller at the higher frequencies, the allowable tolerance on the gap becomes smaller

Depending on the configuration and design choice, conductor 115 may be an open circuit element or short-circuit element, and may be called a stub, in some embodiments. If conductor 115 is short-circuit element, then conductor 115 is grounded at the front edge of ridge 125₂. In these embodiments, semi-conductor 115 should be connected to the front end of ridge 125₂. If, however, conductor 115 is an open circuit element, then conductor 115 is approximately quarter wavelength long at or less the center frequency.

In one example, the coaxial conductors on the connector side are at 50 Ohms, while the coaxial conductors within the opposite ridge are at a very low impedance, quarter wavelength long, open stub. The lower the impedance of this stubs provide wider bandwidth in the BALUN.

In some embodiments, dual ridges 125₁ and 125₂ go upward towards and terminates at or merge with spherical (in this embodiment) elements 140₁ and 140₂. In such embodiments, the spherical elements 140₁ and 140₂ of ridges 125₁ and 125₂ transform the 50 Ohm impedance of antenna 100 to the 377 Ohm impedance of free-space. The spherical structures on end of ridges 125₁ and 125₂ also shape the radiation pattern of the element, providing a very wide beamwidth from the element across the entire frequency range.

In another embodiment, more than one size sphere may be blended on to each ridge to modify the impedance and radiation pattern over the frequency range. In yet another embodiment, small flat spots may be located on the sides away from the ridges to help improve manufacturability without significant degradation of the radiation pattern or impedance match. In yet a further embodiment, the ridges may be terminated in elliptical structures.

It should be appreciated that dual ridges 125₁ and 125₂ perform two functions—(1) increases the bandwidth of the waveguide, and (2) act as a transmission line and an impedance transformer to match waveguide impedance to the impedance of spherical elements 140₁ and 140₂.

It should be appreciated that in the transmission line theory, a quarter wavelength open circuit appears as a short circuit a quarter wave from the end of the stub. This causes a strong coupling of the fields from center conductor 115 to the front edge of ridge 125₂. This allows one to manufacture an open circuit than a short circuit.

Although not required, ridges 125₁ and 125₂ may be tapered. The tapering may allow for impedance matching purposes. This configuration constrains the high frequency between ridges 125₁ and 125₂, whereas the lower frequency completely fills the entire waveguide. This configuration also creates some directivity in the antenna radiation pattern. Bolts 145₁ . . . 145_{N} are used in these embodiments to hold antenna element 100 together.

In certain embodiments, spherical elements 140₁ and 140₂ offer a wide beam width, wide bandwidth, or both. If this was a dipole element/antenna, the fields would propagate as much energy down to the ground plane as vertically, and then the signal that goes down to the ground plane would reflect back out at some frequency creating deep nulls in the radiation pattern every octave of bandwidth. With these embodiments, however, by having ridges 125₁ and 125₂ as transmission lines, a lot of the energy is going upward and not towards the ground plane. Thus, the spherical elements 140₁ and 140₂ are important to achieve this benefit. It may be difficult to create spherical elements 140₁ and 140₂ by additive manufacturing. Instead, spherical elements 140₁ and 140₂ are created via machining. In some embodiments, non-rotationally symmetric elements 140₁ and 140₂ produced by additive manufacturing may be used. However, rotationally symmetric elements may be fabricated through traditional machining processes.

Further, spherical elements 140₁ and 140₂ may be rotationally symmetric spheres. In other embodiments, elements 140₁ and 140₂ are not limited to a sphere but may be ellipsoidal, for example. Additionally, although two spherical elements 140₁ and 140₂ is illustrated, the number of spherical elements 140₁ and 140₂ including the radii may depend on design choice. Additionally, spherical elements 140₁ and 140₂ may be used to shape the radiation pattern across the frequency band. Spherical elements 140₁ and 140₂, however, should be smooth, because rough surface finish on high frequency antennas suffer from significant losses.

In certain embodiments, spherical elements 140₁ and 140₂ includes one or more flat surfaces for the purposes of machining. For example, during machining, spherical element 140₁ and 140₂ may be held for manufacturability. In another example, if the flat spots on spherical elements 140₁ and 140₂ are small, and away from the top/near ridge gap 120, there may be a minor effect on performance. In other embodiments, large flat spots on the sides of the spheres 140₁ and 140₂ may be used in intentionally increase the H-plane beamwidth from the antenna.

Inside of antenna element 100 is a short-circuited cavity 130, which is part of the balun and may help balance the currents.

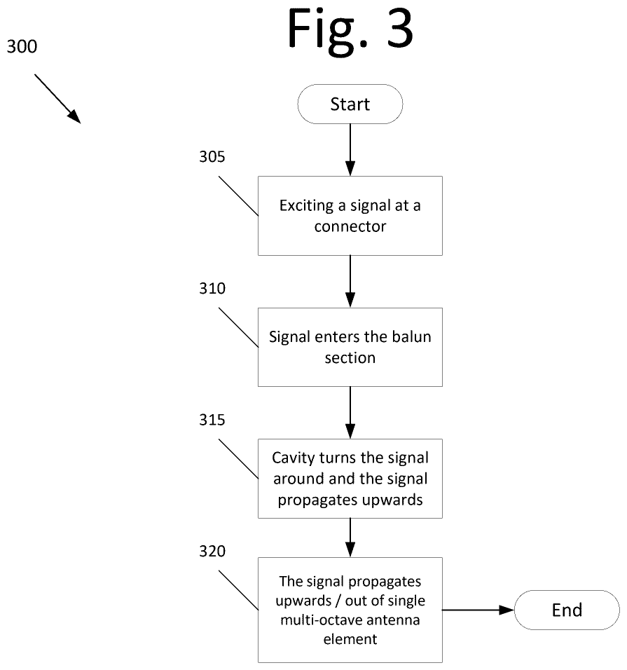

FIG. 3 is a flow diagram illustrating a process 300 for receiving and transmitting with the single multi-octave antenna element, according to an embodiment of the present invention. In some embodiments, the single multi-octave antenna element is a passive device since the multi-octave antenna element does not require amplifiers. Additionally, the single multi-octave antenna element may operate in transmit mode or receive mode.

Process 300 may begin at 305 with exciting a signal at connector. At 310, the signal enters the balun section, which has a cavity underneath. At 315, the cavity underneath the balun forces the signal to turn around and propagate or radiate towards the spheres (or 3D multi-octave matched radiators). At 320, the dual ridge waveguide produces single linear polarization in some embodiments to propagate the signal upwards and out of single multi-octave antenna element.

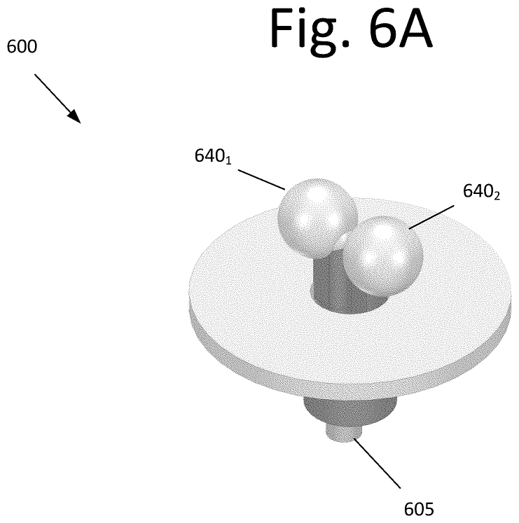

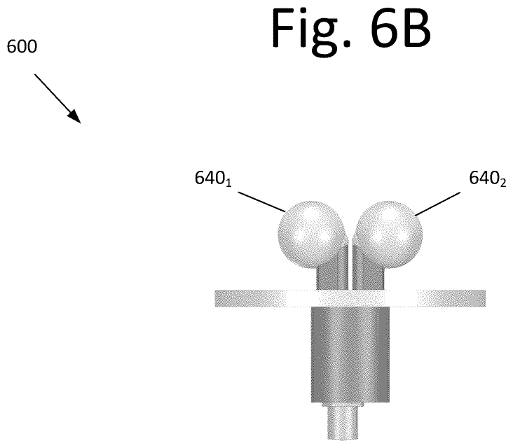

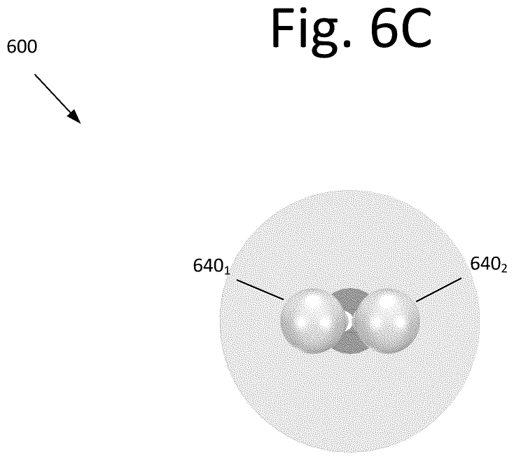

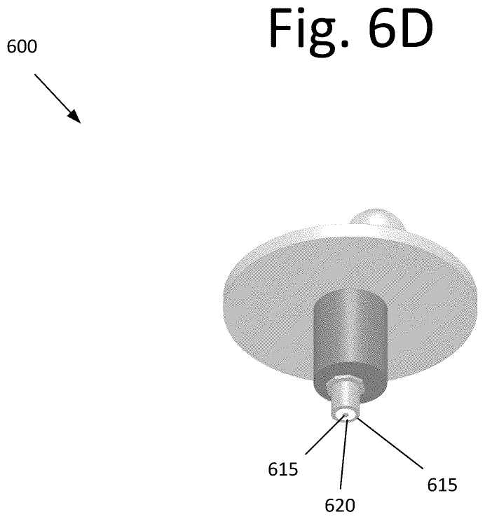

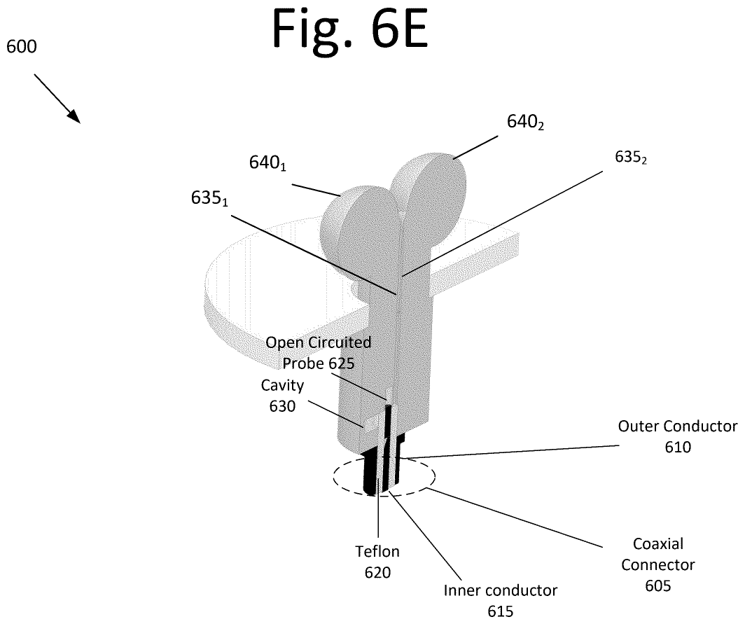

In another embodiment, the single multi-octave antenna element may be duplicated 90 degrees along the antennas axis to produce dual polarization. See, for example, FIGS. 6A-6E, which is an illustration showing dual polarization and is described in more detail below.

In yet another embodiment, circular polarization may also be produced. Circular polarization or any elliptical polarization can be digitally formed from a dual linear polarized antenna embodiment.

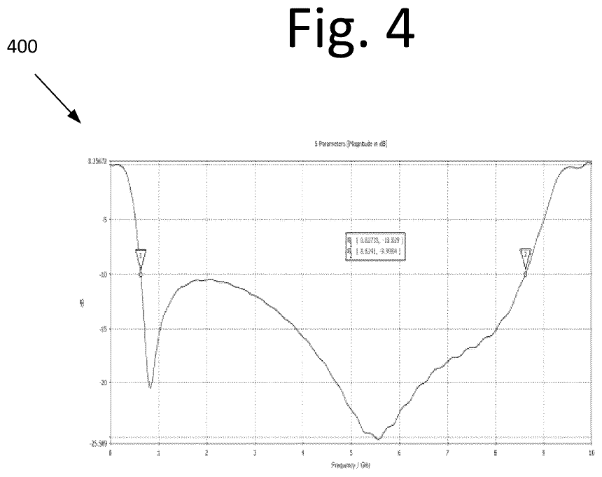

FIG. 4 is a graph 400 illustrating an antenna return loss across 3 octaves of bandwidth, according to an embodiment of the present invention. In these embodiments, graph 400 has a horizontal axis of frequency in GHz and a vertical axis of antenna return loss in dB. The 10 dB return loss band width of this embodiment runs from approximately 900 MHz to approximately 8.6 GHz. This appears over a 3-octave bandwidth.

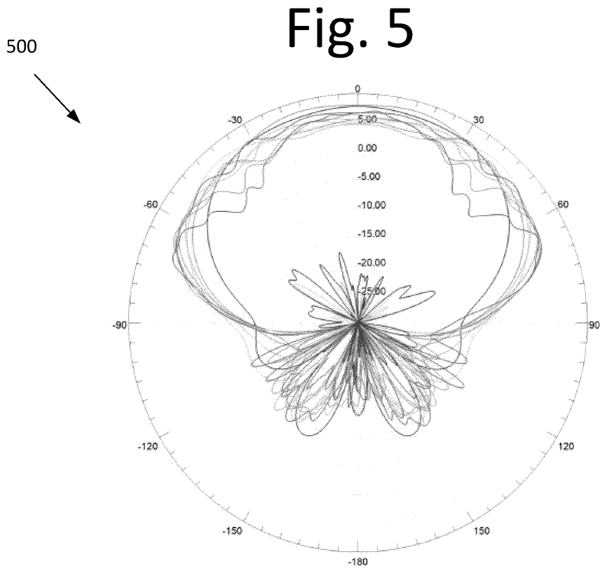

FIG. 5 is a diagram 500 illustrating antenna radiation patterns over a small ground plane, according to an embodiment of the present invention. In some embodiments, FIG. 5 shows the antenna radiation gain patterns at different frequencies across the operating band. Note that antenna pattern extends just beyond plus or minus 60 degrees from boresight. Diffraction off the edges of the small ground plane produce the ripple in the radiation patterns. Larger ground planes will produce smaller ripple in the pattern.

FIGS. 6A-E is a diagram illustrating a single linear polarized antenna 600 with a vertical oriented connector 605, according to an embodiment of the present invention. Similar to FIGS. 1A-E, single linear polarized antenna 600 includes a connector 605 that has an outer conductor 610 and inner conductor 615, but has a vertical orientation. This vertical orientation enables the antennas to be spaced closer together. Between outer conductor 610 and inner conductor 615 is Teflon 620. Teflon 620 may be configured to provide a 50 Ohm characteristic impedance. Inner conductor 615 may lead into an open circuit probe 625 that capacitively couples to the hole in the farthest ridge 140₁ or in a short circuit at the front edge of the farthest ridge 140₁.

In these embodiments, and specifically, FIG. 6E, inner conductor 615 of coaxial connector 605 traverses across cavity 630 and terminates inside a small hole located at the bottom of ridge 635₁, forming an open circuited stub 625. Ridge 635₂ starts at the bottom of cavity 630 and proceeds upward outside the waveguide 660 continuing up to merge with sphere 640₂. Ridge 635₁ starts at the top of cavity 630 and proceeds upward outside waveguide 660 continuing up to merge sphere 640₁. Cavity 630 and open circuited stub 625 form a wide band impedance match along with balanced currents on ridges 635₁ and 635₂. The fields radiate into free space from spheres 640₁ and 640₂.

A cavity 630 (or balun) may partially surround connector 605. In some embodiments, cavity 630 provides a high impedance short circuit and is part of the Balun. Open circuit probe 625 is approximately a quarter wavelength long in the middle of the frequency band and provides a low impedance open circuit that is part of the Balun. Also, in this embodiment, a waveguide formed by two ridges 635₁ and 635₂ starts near the circuited probe 625 and ends at or merges with spherical element 640₁ and 640₂.

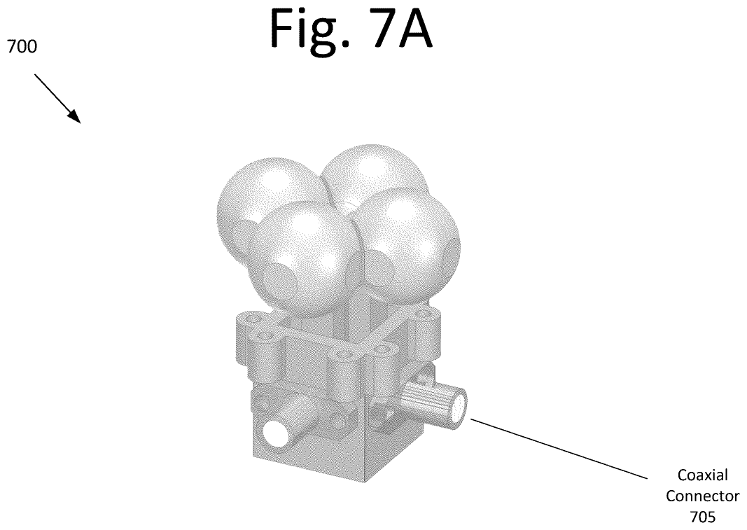

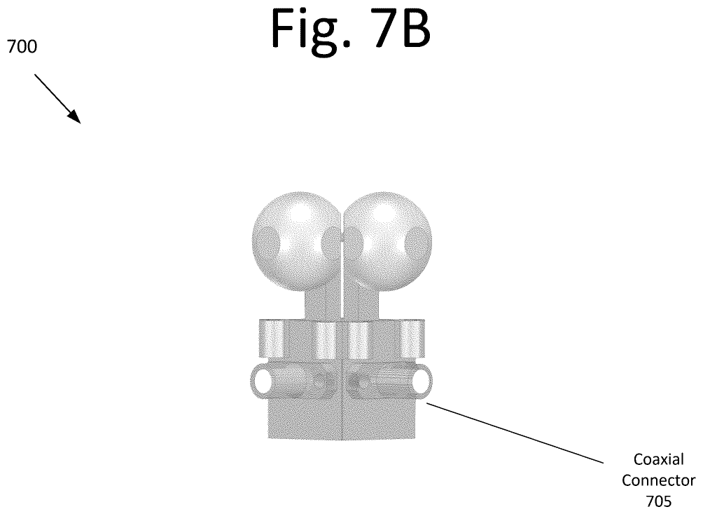

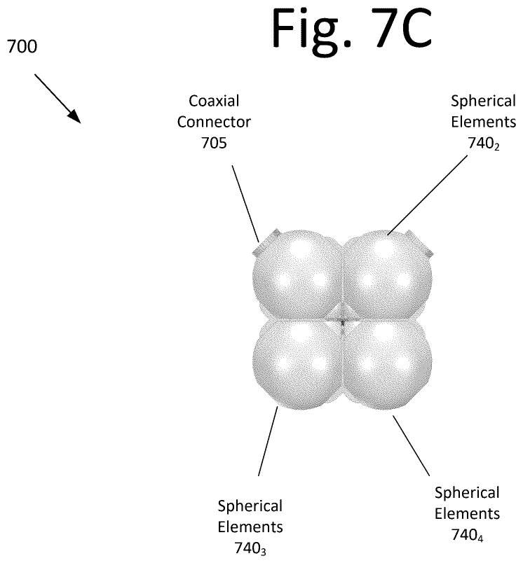

FIGS. 7A-D is a diagram illustrating a dual linear polarized antenna 700 with a plurality of connectors 705, according to an embodiment of the present invention. In these embodiments, and as illustrated in FIGS. 7A-D, spherical elements 7401 to 7404 do not touch allowing for an open space between each element. Although this embodiment may show two connects; other embodiments may include 4 connectors. In other words, the number of connectors used in this embodiment depends on the application for which dual linear polarized antenna 700 is used for.

It should be appreciated that, since the fields in a quad-ridge waveguide are balanced and the polarization of each set of ridges are orthogonal to each other, the dual-orthogonal polarized radiated fields are isolated from each other. This enables frequency reuse in both polarizations and the potential to double the capacity of the data transmitted from the given bandwidth. Additionally, in some embodiments, the dual circular polarization is generated by feeding each ridge in phase quadrature (0, 90, 180, 270). The sense of circular polarization may depend on the direction of the phase rotation.

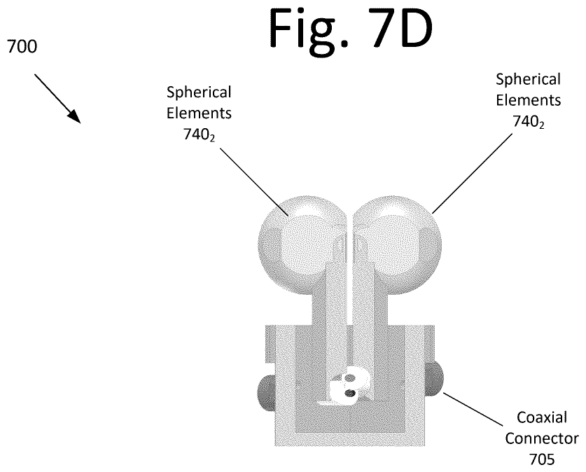

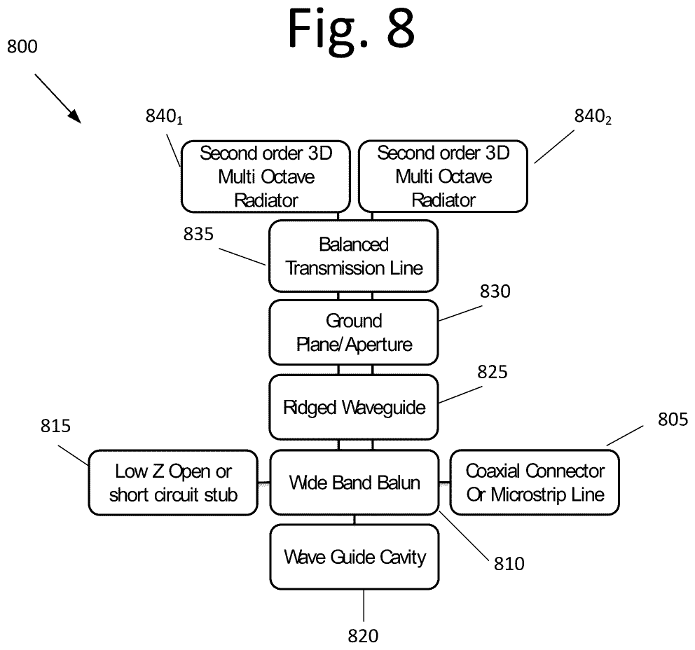

FIG. 8 is a diagram illustrating the propagation of fields through each part of the antenna 800, according to an embodiment of the present invention. In some embodiments, a signal is propagated through coaxial connector or microstrip line 805. Wideband balun 810 and low Z open (or short circuit stub) 815 rotates the signal 90 degrees into cavity 820. From there, signal rotates 180 degrees, and the signal propagates upward through ridged waveguide 825, ground plane aperture 830, balance transmission line 835, and out through second order 3D multi-octave radiators 8401 and 8402.

The fields at lower frequencies radiate from both the aperture of the ground plane and from the spherical elements, creating a well-behaved wide beamwidth radiation pattern. In an alternative embodiment, the fields at the higher frequencies are constrained more within the gap between the two ridges and radiate mostly from the center of the two spheres substantially in the direction of the upper hemisphere. This reduces the magnitude of the fields interacting with the ground plane and further reduces the reflections off the ground plane that can cause deep nulls in the antenna radiation pattern.

It should be appreciated by a person of ordinary skill in the art that antennas are passive, reciprocal devices. This means that the fields behave the same regardless of what direction they are propagating (e.g., transmission or reception).

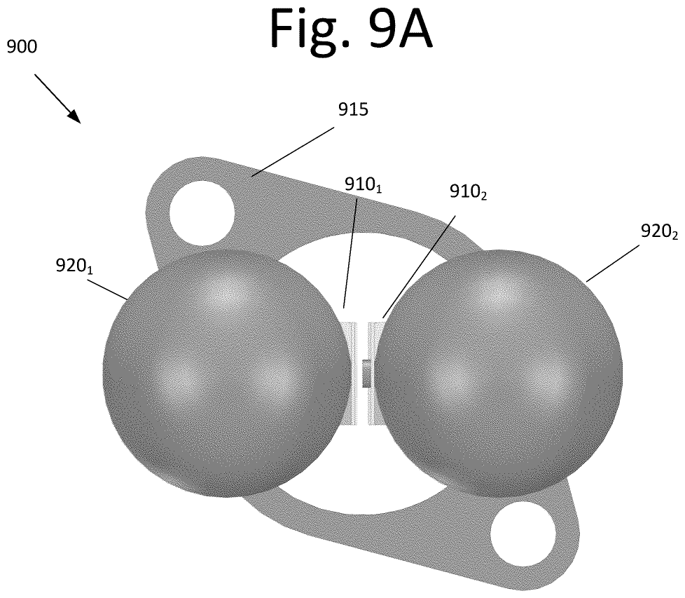

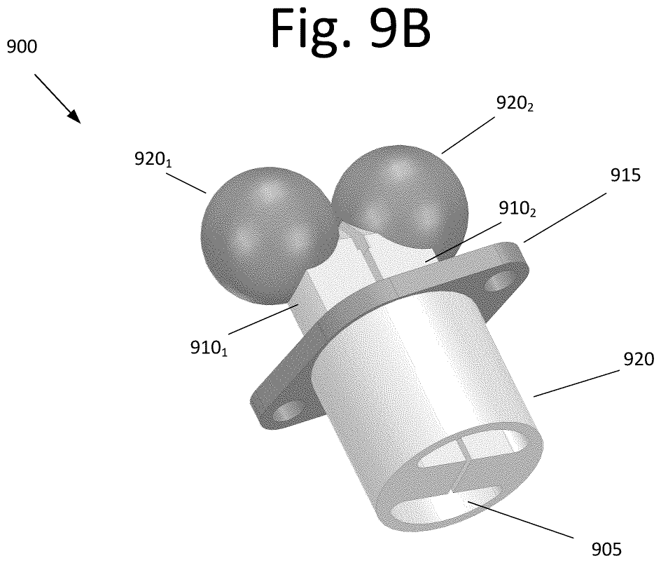

FIGS. 9A and 9A are diagrams illustrating a single multi-octave antenna element with a waveguide input port ideal for use with high power transmission, according to an embodiment of the present invention. In some embodiments, coaxial connector is optional and that a waveguide input 905 may also be used with the embodiments described herein. In these embodiments, the balun is also optional. The ridges 910₁ and 910₂ protruding above ground plane 915 from ridged waveguide 920 below ground plane (e.g., the dual ridge or quad ridge and square, rectangular, or cylindrical waveguide) 915 and terminating in spherical elements s 920₁ and 920₂ are embodiments of the present invention.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. An apparatus, comprising:
a connector with a distal end protruding out of the apparatus and a proximal end encroaching or extending across at least one pair of ridges; and
a ridge waveguide configured to receive a signal from a balun and propagate the signal upward and out of the apparatus, wherein
the ridge waveguide comprises the at least one pair of ridges protruding out of the ridge waveguide and terminating at or merging with a pair of spherical elements.

2. The apparatus of claim 1, wherein the connector is a coaxial connector, a stripline, a microstrip line, or a slot line.

3. The apparatus of claim 2, wherein the connector is an open circuit element or a short circuit element.

4. The apparatus of claim 1, wherein the balun formed by the connector and a cavity is configured to convert an un-balanced transmission line into a balanced transmission line.

5. The apparatus of claim 4, wherein the balun is formed by any combination of the connector, the cavity, and the ridge waveguide.

6. The apparatus of claim 1, wherein the at least one pair of ridges form a gap, allowing a conductor to cross over the one of the at least one pair of ridges into another one of the at least one pair of ridges.

7. The apparatus of claim 1, wherein the ridge waveguide is vertical and a distal end of the ridge waveguide terminates at or merges with one of a plurality of spherical elements.

8. The apparatus of claim 1, further comprising:
a plurality spherical elements and the at least one pair of ridges transform 50 Ohm impedance of the apparatus to 377 Ohm impedance of free-space.

9. The apparatus of claim 8, wherein the plurality of spherical elements are configured to shape a radiation pattern of the plurality of spherical elements, providing a wide beamwidth from the plurality of spherical elements across an entire frequency range.

10. An apparatus, comprising:
a waveguide input configured to receive a signal from an external source, wherein the waveguide configured to propagate the signal upward and out of the apparatus, wherein
the waveguide is located below a ground plane.

11. The apparatus of claim 10, further comprising:
a pair of ridges placed above the ground plane and below a pair of corresponding spherical elements.

12. The apparatus of claim 11, wherein the pair of ridges terminate at the pair of corresponding spherical elements.

13. The apparatus of claim 10, further comprising:
a balun proximate to the waveguide input is configured to convert an un-balanced transmission line into a balanced transmission line.

14. The apparatus of claim 13, wherein the balun is formed by a combination of the waveguide input and the waveguide.

15. The apparatus of claim 10, wherein the pair of ridges form a gap, allowing a conductor to cross over the one of the pair of ridges into another one of the pair of ridges.

16. The apparatus of claim 10, further comprising:
a pair of spherical elements and the pair of ridges transform 50 Ohm impedance of the apparatus to 377 Ohm impedance of free-space.

17. The apparatus of claim 16, wherein the pair of spherical elements are configured to shape a radiation pattern of the elements, providing a very wide beamwidth from the pair of spherical elements across an entire frequency range.

18. An apparatus, comprising:
a connector with a distal end protruding out of the apparatus and a proximal end terminating at or on a front surface of an opposite ridge forming a short circuit; and
a waveguide is configured to receive a signal from a balun and propagate the signal upward and out of the apparatus, and
the waveguide comprising a pair of ridges protruding out and terminating at or merging with a pair of spherical elements.

19. The apparatus of claim 18, further comprising:
a balun formed by the connector and a cavity is configured to convert an un-balanced transmission line into a balanced transmission line, wherein
the balun is formed by a combination of the connector and the waveguide.

20. The apparatus of claim 18, wherein the waveguide is vertical and a distal end of the waveguide terminates at or merges with one of a plurality of spherical elements.

21. The apparatus of claim 18, further comprising:
a plurality spherical elements and the pair of ridges transform 50 Ohm impedance of the apparatus to 377 Ohm impedance of free-space.
